(19) United States
(12) Patent Application Publication
(10) Pub. No.: US 2022/0331947 A1
(43) Pub. Date: Oct. 20, 2022

(54) WEARABLE EXOSKELETON WITH AUXILIARY BACK FRAME SUPPORT

(71) Applicant: OTTOP CO., LTD, Taoyuan City (TW)

(72) Inventor: CHUN-HSIEN LEE, Taoyuan City (TW)

(21) Appl. No.: 17/721,089

(22) Filed: Apr. 14, 2022

(30) Foreign Application Priority Data
Apr. 20, 2021 (TW) 110114064

(51) Int. Cl. B25J 9/00; B25J 17/00

(52) U.S. Cl. CPC B25J 9/0006; B25J 9/0015; B25J 17/00

(57) ABSTRACT

A wearable exoskeleton comprises a back frame set and a lower limb link rod set. The back frame set comprises a sliding rod and an object seat. The object seat is coupled to the sliding rod and configured for carrying object. One end of the lower limb link rod set is coupled to the object seat. The back frame set is worn on the back of the user. The lower limb link rod set is worn on the lower limb of the user for responding to the flexing or erecting movements of the user's lower limb. When the other end of the lower limb link rod set contacts the ground with the action of the lower limb, the ground provides an upward reaction force, and the reaction force is transmitted to the object seat through the lower limb link rod set to push up the object.

The present application is based on, and claims priority from, Republic of China (Taiwan) application number TW110114064, filed on 2021 Apr. 20, the disclosure of which is hereby incorporated by reference herein in its entirety.

### BACKGROUND OF THE INVENTION

### Field of the Invention

The present invention relates to a wearable exoskeleton, especially a non-powered wearable exoskeleton that assists in supporting the heavy objects carried by the user.

### Description of the Prior Art

Wearable exoskeletons have gradually been used in medical, industrial and military applications. Medical exoskeletons are designed to help users regain mobility. Industrial and military exoskeletons help prevent injury and enhance the user's strength. Industrial exoskeletons are especially used to reduce the load on workers during labor, prevent workers from getting injured and improve their stamina and physical strength.

Different types of industrial exoskeletons are suitable for people with different labor services, such as weeding, spraying, logistics and warehousing, and delivery. Their waists, hips, and knees are particularly prone to muscle and bone injuries due to long-term heavy loads. In order to prevent or mitigate such occupational injuries, exoskeletons with auxiliary back frames are a good solution.

Exoskeletons are usually divided into powered and non-powered ones. The powered exoskeleton control system controls the joint trajectory of the exoskeleton and guides the movement of the exoskeleton structure. However, when individual users have different movement habits or need to perform instantaneous and precise operations, the powered exoskeleton may cause wrong motion trajectories. In addition, powered exoskeletons must be equipped with power sources, actuating elements, sensing elements and complex electromechanical designs, which makes the existing exoskeleton assistive devices heavy and inconvenient to wear, expensive and difficult to maintain.

Therefore, there is still a lack of a non-active power exoskeleton technology that effectively guides and offsets the weight carried in the technical field, which has become a problem to be solved.

### SUMMARY OF THE INVENTION

In view of this, the present invention provides a non-active power wearable exoskeleton with auxiliary back frame support for a user to wear to assist the user to carry an object. The wearable exoskeleton with auxiliary back frame support comprises a back frame set and a lower limb link rod set. The back frame set further comprises a sliding rod and an object seat. The object seat is coupled to the sliding rod and capable of sliding, and the object seat is configured for carrying the object. The lower limb link rod set comprises a plurality of lower link rods connected in series and pivotally connected to each other, and one end of the lower limb link rod set is coupled to the object seat. When the wearable exoskeleton is worn by the user, the back frame set is fixed on the back of the user, and the lower limb link rod set is fixed on the outer side of at least one lower limb of the user, and the lower limb link rod set is actuated in response to the flexing or erecting movements of the user's lower limb. When the other end of the lower limb link rod set contacts the ground with the action of the at least one lower limb, the ground provides an upward reaction force, and the reaction force is transmitted to the object seat through the lower limb link rod set to push up the object.

The object seat of the wearable exoskeleton with auxiliary back frame support further comprises a load slider and a support slider. The load slider slidably is configured on the sliding rod and having a bracket. The support slider slidably is configured on the sliding rod. The support slider is located under the load slider and is coupled to one end of the lower limb link rod set.

The wearable exoskeleton with auxiliary back frame support further comprises at least two sliding rods, at least two support sliders and at least two lower limb link rod sets symmetrically configured according to the user's sagittal plane respectively. Wherein, the support sliders are a left support slider and a right support slider respectively and slidably coupled to the at least two sliding rods. When the other end of the lower limb link rod set on the left side contacts the ground and the other end of the lower limb link rod set on the right side leaves the ground, the left support slider supports the load slider.

Wherein, one of the left support slider and the right support slider has a longitudinal protruding portion, and the other has a longitudinal concave portion. The longitudinal protruding portion and the longitudinal concave portion cooperate with each other to limit the rotation of the support sliders in horizontal direction.

Wherein, when the user walks, the left support slider and the right support slider support the load slider by turns.

The wearable exoskeleton with auxiliary back frame support further comprises a hip link rod, and the position of which is corresponding to the user's hip. One end of the hip link rod is coupled to the support slider of the object seat, and the other end of the hip link rod is pivotally connected to the lower limb link rod set. Wherein, when the other end of the lower limb link rod set contacts the ground with the movement of the at least one lower limb of user, the reaction force provided by the ground is sequentially transmitted to the bracket through the lower limb link rod set, the hip link rod, the support slider, and the load slider to push up the object.

Wherein, the lower limb link rod set further comprises an above-knee link rod group, a knee joint group and an under-knee link rod group. One end of the above-knee link rod group is pivotally connected to the other end of the hip link rod, and the above-knee link rod includes an elastic element coaxial with the above-knee link rod group. One end of the knee joint group is pivotally connected to the other end of the above-knee link rod group. The under-knee link rod group is pivotally connected to the other end of the knee joint group.

In an embodiment, the elastic element is an extension spring. When the other end of the lower limb link rod set extends to contact the ground, the extension spring is stretched to generate a spring restoring force to offset part of the load.

In another embodiment, the elastic element is a compression spring. When the other end of the lower limb link rod set extends to contact the ground, the compression spring is compressed to generate a spring restoring force to offset part of the load.

The lower limb link rod set further comprises an above-ankle link rod, a return cylinder and an under-ankle link rod. The above-ankle link rod is hinged to the under-knee link rod group. The return cylinder is hinged to the upper ankle link rod, and the return cylinder comprises a round wire spring. The under-ankle link rod is hinged to the return cylinder and is configured to contact the ground.

In summary, the wearable exoskeleton with auxiliary back frame support disclosed in the present invention is suitable for being worn on the back and lower body of the human body, and the back frame is provided with the object seat connected by the link rods to extend to contact the ground. When the object is fixed on the object seat, part of the weight of the load object is transmitted to the ground through the link rods, which produces the effect of auxiliary support and achieves the effect of reducing the load imposed on the user. The elastic element therein can generate a reverse force corresponding to the gravity, further reducing the load imposed on the user. The support sliders of the object seat are divided into left support slider and right support slider, which can respectively produce up and down displacement corresponding to the sliding state of the left and right feet of the human body, thereby achieving the effect that the support sliders take turns supporting the load during walking without restraining each other's elbows.

The advantages and spirit of the present invention can be further understood by the following detailed description of the invention and the accompanying drawings.

### BRIEF DESCRIPTION OF THE APPENDED DRAWINGS

Some of the embodiments will be described in detail, with reference to the following figures, wherein like designations denote like members, wherein:

FIG. 1 shows a schematic diagram of a user wearing a wearable exoskeleton with auxiliary back frame support according to an embodiment of the present invention.

FIG. 2 shows a schematic diagram of the wearable exoskeleton with auxiliary back frame support according to an embodiment of the present invention.

FIG. 3 shows a schematic diagram of the wearable exoskeleton with auxiliary back frame support according to an embodiment of the present invention for standing.

FIG. 4 shows a schematic diagram of the wearable exoskeleton with auxiliary back frame support according to an embodiment of the present invention for leg raising.

FIG. 5 shows a schematic diagram of a back frame set of the wearable exoskeleton with auxiliary back frame support according to an embodiment of the present invention.

FIG. 6 shows a schematic diagram of a hip link rod of the wearable exoskeleton with auxiliary back frame support according to an embodiment of the present invention.

FIG. 7 shows a front view diagram of a lower limb link rod set of the wearable exoskeleton with auxiliary back frame support according to an embodiment of the present invention.

FIG. 8 shows a side view diagram of the lower limb link rod set of the wearable exoskeleton with auxiliary back frame support according to an embodiment of the present invention.

FIG. 9 shows a front view diagram of an elastic telescopic set of the wearable exoskeleton with auxiliary back frame support according to an embodiment of the present invention.

FIG. 10 shows a side perspective view diagram of the elastic telescopic set of the wearable exoskeleton with auxiliary back frame support according to an embodiment of the present invention.

FIG. 11 shows a rear perspective view diagram of a return cylinder of the wearable exoskeleton with auxiliary back frame support according to an embodiment of the present invention.

The advantages, spirits, and features of the present invention will be explained and discussed with embodiments and figures as follows.

### DETAILED DESCRIPTION OF THE INVENTION

In order to make the advantages, spirit and features of the present invention easier and clearer, it will be detailed and discussed in the following with reference to the embodiments and the accompanying drawings.

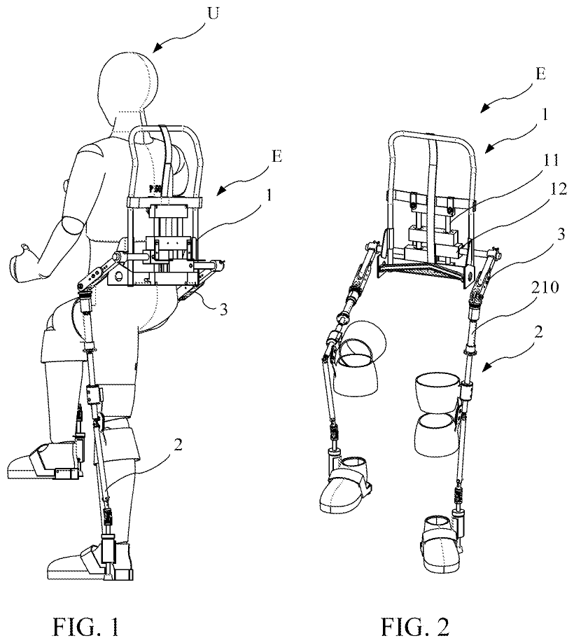

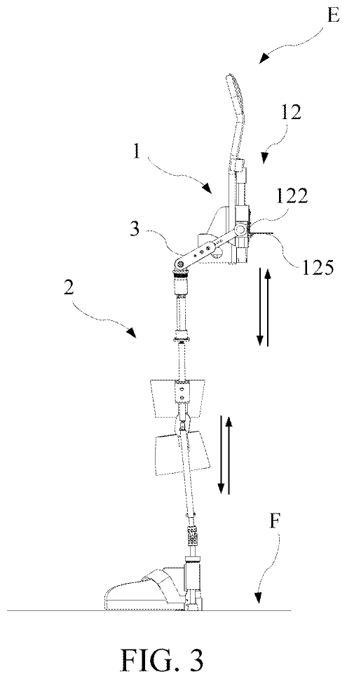

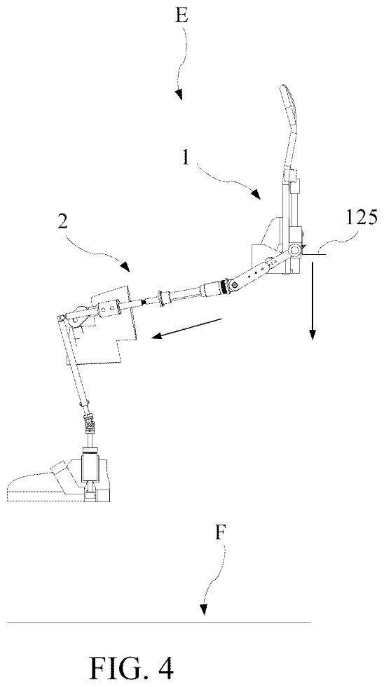

Please refer to FIG. 1. to FIG. 4. FIG. 1 shows a schematic diagram of a user wearing a wearable exoskeleton with auxiliary back frame support according to an embodiment of the present invention. FIG. 2 shows a schematic diagram of the wearable exoskeleton with auxiliary back frame support according to an embodiment of the present invention. FIG. 3 shows a schematic diagram of the wearable exoskeleton with auxiliary back frame support according to an embodiment of the present invention for standing. FIG. 4 shows a schematic diagram of the wearable exoskeleton with auxiliary back frame support according to an embodiment of the present invention for leg raising.

The present invention provides a non-active power wearable exoskeleton with auxiliary back frame support E for a user U to wear to assist the user U to carry objects. The wearable exoskeleton with auxiliary back frame support E comprises a back frame set 1 and a lower limb link rod set 2. The back frame set 1 further comprises a sliding rod 11 and an object seat 12. The object seat 12 is coupled to the sliding rod 11 and can slide up and down along the axis of the sliding rod 11, and the object seat 12 is configured for carrying objects. The lower limb link rod set 2 comprises a plurality of lower link rods that are connected in series and pivotally connected to each other, and one end of the lower limb link rod set 2 is coupled to the object seat 12.

When the wearable exoskeleton with auxiliary back frame support E is worn by the user U, the back frame set 1 is fixed on the back of the user U, and the lower limb link rod set 2 is fixed on the outer side of at least one lower limb of the user U, and the lower limb link rod set 2 is actuated in response to the flexing or erecting movements of the lower limb of the user U.

When the other end of the lower limb link rod set 2 contacts the ground F with the action of the lower limb, the ground F provides an upward reaction force, and the reaction force is transmitted to the object seat 12 through the lower limb link rod set 2 to push up the object, as shown in FIG. 3.

When the other end of the lower limb link rod set 2 leaves the ground F with the action of the lower limb, the lower limb link rod set 2 does not provide the upward reaction force, and the weight of the object is applied to a bracket 125 of the object seat 12 and the object seat 12 sinks.

The action of the plurality of lower link rods connected in series and pivotally connected to each other corresponds to the flexion and extension movement of the lower limbs of the user U, and the axis of the action of the lower link rods roughly coincides with the axis of the flexion and extension movement of the user U.

The lower limb link rod set 2 is coupled to the object seat 12 that slides up and down, so that the weight of the object seat 12 and the object is guided down to the lower limb link rod set 2 along the direction of the sliding rod 11. In this way, the lower limb link rod set 2 can bear the weight of the object to the maximum extent, and then transmit it to the ground. If the object seat 12 is a fixed type, the force is easily distributed to the user U obliquely, and the weight of the object is borne by the waist and lower limbs of the user U.

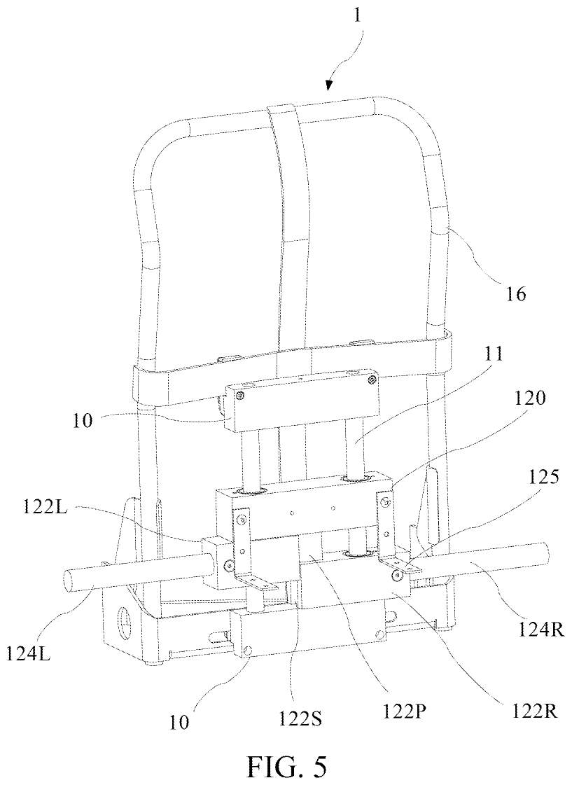

Please refer to FIG. 3. and FIG. 5. FIG. 5 shows a schematic diagram of the back frame set of the wearable exoskeleton with auxiliary back frame support according to an embodiment of the present invention. The object seat 12 of the wearable exoskeleton with auxiliary back frame support E further comprises a load slider 120 and a support slider 122. The load slider 120 is slidably disposed on the sliding rod 11 and has a bracket 125. The bracket 125 can be a simple structure such as an angle steel, an angle iron, or a platform, a basket shape, a basin shape, or even a tenon, a snap part, a magnetic part, to match the object, so that the object can be stably arranged on the bracket 125. The support slider 122 is slidably disposed on the sliding rod 11 and is located below the load slider 120. The back frame set 1 also comprises a back frame 16 as the basic structure of the back frame set 1. The back frame 16 can be placed on the back of the user U through binding members such as straps; for example, a double-shoulder piggyback type where the binding member goes around the shoulders, or a horizontal binding from the waist, chest to the abdomen.

The wearable exoskeleton with auxiliary back frame support E further comprises at least two sliding rods 11, at least two support sliders 122, at least two slider crossbars, at least two hip link rods 3 and at least two lower limb link rod sets 2 symmetrically configured according to the sagittal plane of the user U respectively. The support sliders 122 are a left support slider 122L and a right support slider 122R respectively and slidably coupled to the at least one sliding rod 11. When the other end of the lower limb link rod set 2 on the left side contacts the ground F and the other end of the lower limb link rod set 2 on the right side leaves the ground F, the left support slider 122L supports the load slider 120.

The two slider crossbars are the left slider crossbar 124L and the right slider crossbar 124R, respectively. One end of the left slider crossbar 124L is fixed on the left support slider 122L and extends to the left side. The other end of the left slider crossbar 124L is adjustable and fixed on one end of a left hip link rod 3L. The right slider crossbar 124R is fixed on the right support slider 122R and extends to the right side. The other end of the right slider crossbar 124R is adjustable and fixed to one end of a right hip link rod 3R.

The user U can support the wearable exoskeleton with auxiliary back frame support E arranged symmetrically on the left and right sides, or can choose the wearable exoskeleton with auxiliary back frame support E with one side. The so-called unilateral wearable exoskeleton with auxiliary back frame support E means that one leg of the user is not equipped with the lower limb link rod set 2, or the lower limb link rod set 2 cannot transmit the reaction force to the object seat. At this time, the skeleton on the other side can still move normally, achieving the effect of reducing the strength of one leg.

Any support slider 122 is crossed by two or more sliding rods 11, so that the support slider 122 does not rotate in the horizontal direction. Alternatively, one of the left support slider 122L and the right support slider 122R has a longitudinally protruding portion 122P, and the other has a longitudinally concave portion 122S. The longitudinal protruding portion 122P and the longitudinally concave portion 122S cooperate with each other to limit the horizontal rotation of the left support slider 122L and the right support slider 122R. Longitudinal direction means that the direction is same as that of the sliding rods 11, so that the support slider 122 can slide up and down. Taking FIG. 5 as an example, the left support slider 122L has the longitudinal protruding portion 122P, and the right support slider 122R has the longitudinal concave portion 122S. The longitudinal protruding portion 122P penetrates into the longitudinal concave portion 122S, so the left support slider 122L and the right support slider 122R cannot rotate in the horizontal direction.

Please refer to FIG. 1, FIG. 3 to FIG. 5. When the user U walks, the left support slider 122L and the right support slider 122R support the load slider 120 by turns. Taking FIG. 1 as an example, when the left foot of the user U stands upright on the ground F, the left side state of the wearable exoskeleton with auxiliary back frame support E is as shown in FIG. 3. At this time, the left support slider 122L pushes upward to the load slider 120, and transmits the reaction force provided by the ground F to the object seat 12, thereby offsetting the weight of the object. In FIG. 1, when the right foot of the user U is bent and leaves the ground F, the right side state of the wearable exoskeleton with auxiliary back frame support E is shown in FIG. 4. At this time, the right support slider 122R leaves the load slider 120 downward, and the right foot does not bear the weight of the object, but can bend and lift the leg normally.

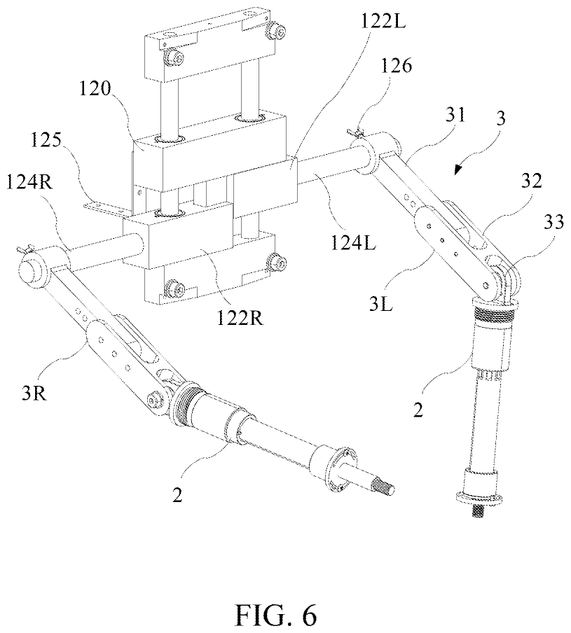

Please refer to FIG. 1 and FIG. 6. FIG. 6 shows a schematic diagram of a hip link rod of the wearable exoskeleton with auxiliary back frame support according to an embodiment of the present invention. One end of the hip link rod 3 is coupled to the support slider 122 of the object seat 12, and the other end of the hip link rod 3 is pivotally connected to the lower limb link rod set 2. When the other end of the lower limb link rod set 2 contacts the ground with the movement of the at least one lower limb of user, the reaction force provided by the ground is sequentially transmitted to the bracket 125 through the lower limb link rod set 2, the hip link rod 3, the slider crossbar 124, the support slider 122, and the load slider 120 to push up the object.

The hip link rod 3 is further divided into the left hip link rod 3L and the right hip link rod 3R. The left hip link rod 3L is locked on the other end of the left slider crossbar 124L. The right hip link rod 3R is locked to the other end of the right slider crossbar 124R. One of the main functions of the slider crossbar 124 and the hip link rod 3 is to extend the back frame structure from the back of the user U to the outer side of the thigh of the user U. There is a dish bolt 126 between the hip link rod 3 and the slider crossbar 124. By loosening the connection between the hip link rod 3 and the slider crossbar 124 by the dish bolt 126, the width of the wearable exoskeleton with auxiliary back frame support E can be adjusted according to the width of the hip of the user U, and can adjust the angle between the hip link rod 3 and the horizontal plane.

The hip link rod 3 further comprises a hip upper swingarm 31 and a hip lower swingarm 32. The hip lower swingarm 32 is sleeved outside the hip upper swingarm 31 and locked with each other. The hip upper swingarm 31 and the hip lower swingarm 32 are also detachable to adjust the length of the hip link rod 3 to match the thickness of the hip of the user U.

The hip link rod 3 also has a spherical bearing 33 for connecting the lower limb link rod set 2. The spherical bearing 33 is beneficial to the multi-directional rotation of the lower limb link rod set 2.

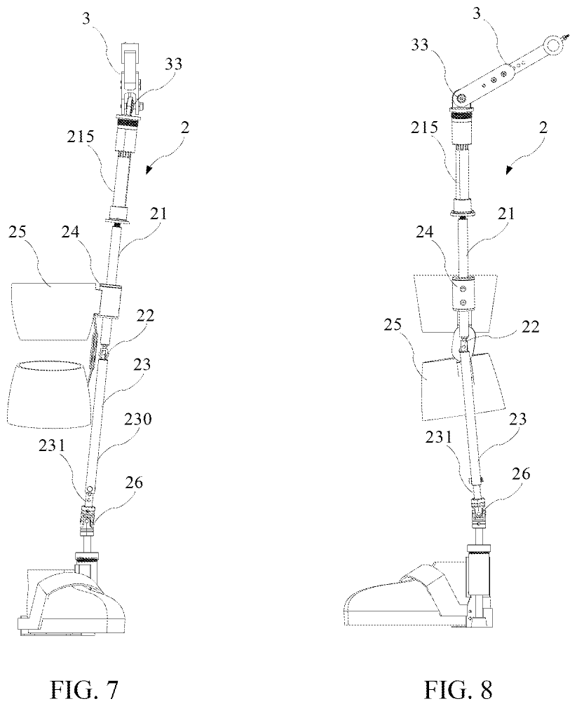

Please refer to FIG. 3, FIG. 7 and FIG. 8. FIG. 7 shows a front view diagram of a lower limb link rod set of the wearable exoskeleton with auxiliary back frame support according to an embodiment of the present invention. FIG. 8 shows a side view diagram of the lower limb link rod set of the wearable exoskeleton with auxiliary back frame support according to an embodiment of the present invention. The lower limb link rod set 2 further comprises an above-knee link rod group 21, a knee joint group 22 and an under-knee link rod group 23. One end of the above-knee link rod group 21 is pivotally connected to the other end of the hip link rod 3, and comprises an elastic element 215 coaxial with the above-knee link rod group 21. One end of the knee joint group 22 is pivotally connected to the other end of the above-knee link rod group 21. The under-knee link rod group 23 is pivotally connected to the other end of the knee joint group 22.

The lower limb link rod set 2 further comprises a leg sliding slip 24, a leg restraint 25, and an ankle universal joint 26. The leg sliding slip 24 is slidably disposed on the above-knee link rod group 21. The leg restraint 25 is connected to the leg sliding slip 24. The leg restraint 25 is further divided into an above-knee restraint and an under-knee restraint, which are connected and can be actuated with the bending of the knee. The ankle universal joint 26 is configured for cooperating with the multi-directional movement of the ankle joint.

The under-knee link rod group 23 further comprises an under-knee link rod tube 230 and an adjust link rod 231, and the adjust link rod 231 penetrates into the under-knee link rod tube 230 from below. There are holes on both sides to allow the pins to pass through. According to the relative fixed positions of the under-knee link rod tube 230 and the adjust link rod 231, the length of the under-knee link rod group 23 can be adjusted according to the foot lengths of different users.

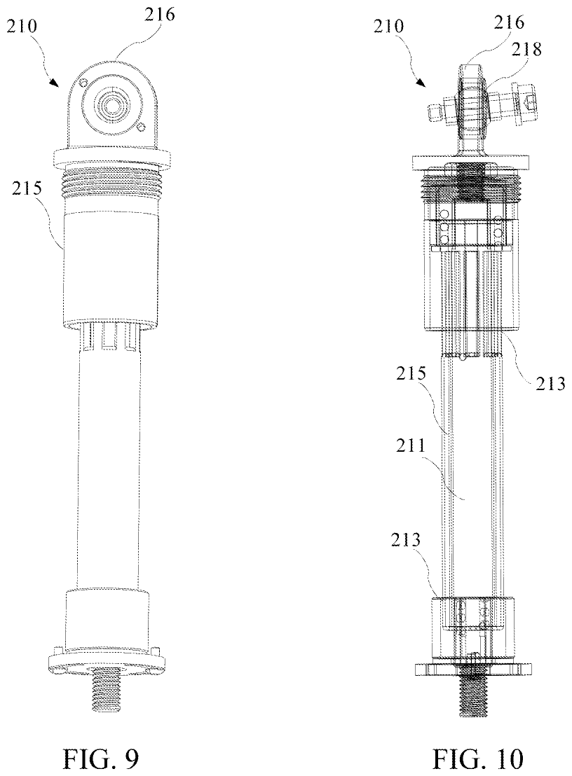

Please refer to FIG. 7, FIG. 9 and FIG. 10. FIG. 9 shows a front view diagram of an elastic telescopic set of the wearable exoskeleton with auxiliary back frame support according to an embodiment of the present invention. FIG. 10 shows a side perspective view diagram of the elastic telescopic set of the wearable exoskeleton with auxiliary back frame support according to an embodiment of the present invention. There is also an elastic telescopic group 210 in the lower limb link rod set 2. The elastic telescopic set 210 comprises the elastic element 215, a guide sleeve 213, a support rod 211, a pivot eye seat 216, and the spherical bearing 218. The elastic element 215 is sleeved outside the support rod 211. The guide sleeve 213 clamps the elastic element 215. The spherical bearing 218 is provided on the pivot eye seat 216, and the pivot eye seat 216 is configured for engaging with the hip link rod 3.

In one embodiment, the elastic element 215 is an extension spring. When the other end of the lower limb link rod set 2 extends to contact the ground, the extension spring is stretched to generate a spring restoring force to offset part of the load.

In another embodiment, the elastic element 215 is a compression spring. When the other end of the lower limb link rod set extends to contact the ground, the compression spring is compressed to generate a spring restoring force to offset part of the load.

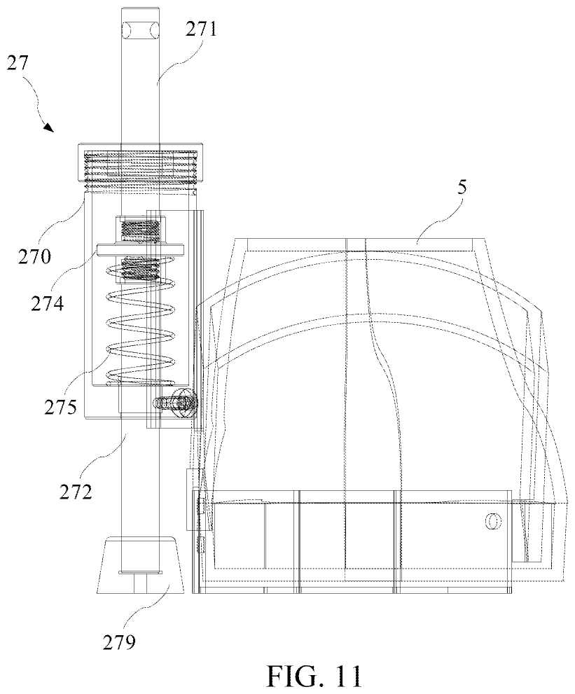

Please refer to FIG. 7, and FIG. 11. FIG. 11 shows a rear perspective view diagram of a return cylinder of the wearable exoskeleton with auxiliary back frame support according to an embodiment of the present invention. The lower limb link rod set 2 also comprises a return cylinder set 27. The return cylinder set 27 further comprises an above-ankle link rod 271, a return cylinder 270 and an under-ankle link rod 272. The above-ankle link rod 271 is hinged to the under-knee link rod group 23 via the ankle universal joint 26. The return cylinder 270 is hinged to the above-ankle link rod 271, and comprises a connecting seat 274 and a round wire spring 275. The connecting seat 274 is configured for fixing the above-ankle link rod 271 and the under-ankle link rod 272. One end of the under-ankle link rod 272 is hinged to the return cylinder 270, and the other end is provided with a footpad 279 for contacting the ground. The return cylinder set 27 is fixed to a shoe cover 5, and the shoe cover 5 can be tied with the user's own shoes.

When the knee of the user's unilateral foot is bent and moved forward with a stride, the lower limb link rod set 2 of the bent foot does not support the weight of the back frame. However, based on the length of the lower limb link rod set 2 and its own weight, the lower limb link rod set 2 for bending the foot will sag and the bottom end protrudes beyond the sole. When the lower limb link rod set 2 exceeds the sole of the shoe, it is easy to drag on the ground, which seriously interferes with the user's walking on the ground. The setting of the round wire spring 275 in the return cylinder 27 can offset the weight of the lower limb link rod set 2 upward, thereby restraining the lower limb link rod set 2 to sag extension length not exceeding the sole of the user's foot, so as not to hinder walking.

In addition, when the ground is uneven, the shoe pedal position and the foot pad position may fall on different levels. At this time, the return cylinder 270 can also provide a buffer space.

Please refer to FIG. 4, FIG. 7 and FIG. 11, taking the bending action of FIG. 4 as an example for description. When the knee is bent and moved forward, the elastic element 215 is not stressed, and the above-knee link rod group 21 extends along with the leg slip 24. At the same time, the return cylinder set 27 lifts the above-ankle link 271 through the round wire spring 275. The under-knee link rod group 23 and the above-knee link rod group 21 connected by the ankle universal joint 26 form a specific geometric shape at the knee joint group 22 to absorb the length variation of the lower limb link rod set 2 in the elastic telescopic set 210.

In summary, the wearable exoskeleton with auxiliary back frame support disclosed in the present invention is suitable for being worn on the back and lower body of the human body, and the back frame is provided with the object seat extending to contact the ground through the linkage of the link rods. When the object is fixed on the object seat, part of the weight of the load object is transmitted to the ground through the link rod, which produces the effect of auxiliary support and achieves the effect of reducing the load imposed on the user. The elastic element therein can generate a reverse force corresponding to the gravity, further reducing the load imposed on the user. The support slider of the object seat is divided into left and right sides, which can respectively produce up and down displacement corresponding to the sliding state of the left and right feet of the human body, thereby achieving the effect that the sliders take turns supporting the load during walking without restraining each other's elbows

With the detailed description of the above embodiments, it is hoped that the features and spirit of the present invention can be more clearly described, and the scope of the present invention is not limited by the embodiments disclosed above. On the contrary, the intention is to cover various changes and equivalent arrangements within the scope of the patents to be applied for in the present invention. Therefore, the scope of the patentable scope for which the present invention is claimed should be construed in the broadest sense in accordance with the above description so as to encompass all possible modifications and equivalent arrangements.

What is claimed is:

1. A wearable exoskeleton with auxiliary back frame support for a user to wear to assist the user to carry an object, the wearable exoskeleton comprising:
a back frame set, further comprising:
a sliding rod; and
an object seat coupled to the sliding rod and capable of sliding, and the object seat being configured for carrying the object; and
a lower limb link rod set comprising a plurality of lower link rods connected in series and pivotally connected to each other, one end of the lower limb link rod set being coupled to the object seat;
wherein, when the wearable exoskeleton is worn by the user, the back frame set is fixed on the back of the user, and the lower limb link rod set is fixed on the outer side of at least one lower limb of the user, and the lower limb link rod set is actuated in response to the flexing or erecting movements of the user's lower limb;
wherein, when the other end of the lower limb link rod set contacts the ground with the action of the at least one lower limb, the ground provides an upward reaction force, and the reaction force is transmitted to the object seat through the lower limb link rod set to push up the object.

2. The wearable exoskeleton with auxiliary back frame support of claim 1, wherein the object seat further comprises:
a load slider slidably configured on the sliding rod and having a bracket; and
a support slider slidably configured on the sliding rod, the support slider being located under the load slider and coupled to one end of the lower limb link rod set.

3. The wearable exoskeleton with auxiliary back frame support of claim 2 further comprising at least two sliding rods, at least two support sliders and at least two lower limb link rod sets symmetrically configured according to the user's sagittal plane respectively, wherein the support sliders are a left support slider and a right support slider respectively and slidably coupled to the at least one sliding rod, when the other end of the lower limb link rod set on the left side contacts the ground and the other end of the lower limb link rod set on the right side leaves the ground, the left support slider supports the load slider.

4. The wearable exoskeleton with auxiliary back frame support of claim 3, wherein one of the left support slider and the right support slider has a longitudinal protruding portion, and the other has a longitudinal concave portion, the longitudinal protruding portion and the longitudinal concave portion cooperate with each other to limit the rotation of the support sliders in horizontal direction.

5. The wearable exoskeleton with auxiliary back frame support of claim 4, wherein when the user walks, the left support slider and the right support slider support the load slider by turns.

6. The wearable exoskeleton with auxiliary back frame support of claim 2, further comprising a hip link rod, the position of which being corresponding to the user's hip, one end of the hip link rod being coupled to the support slider of the object seat, and the other end of the hip link rod being pivotally connected to the lower limb link rod set, wherein when the other end of the lower limb link rod set contacts the ground with the movement of the at least one lower limb of user, the reaction force provided by the ground is sequentially transmitted to the bracket through the lower limb link rod set, the hip link rod, the support slider, and the load slider to push up the object.

7. The wearable exoskeleton with auxiliary back frame support of claim 6, wherein the lower limb link rod set further comprises:
an above-knee link rod group, one end of which is pivotally connected to the other end of the hip link rod, the above-knee link rod includes an elastic element coaxial with the above-knee link rod group;
a knee joint group, one end of which is pivotally connected to the other end of the above-knee link rod group; and
an under-knee link rod group is pivotally connected to the other end of the knee joint group.

8. The wearable exoskeleton with auxiliary back frame support of claim 7, wherein the elastic element is an extension spring, when the other end of the lower limb link rod set extends to contact the ground, the extension spring is stretched to generate a spring restoring force to offset part of the load.

9. The wearable exoskeleton with auxiliary back frame support of claim 7, wherein the elastic element is a compression spring, when the other end of the lower limb link rod set extends to contact the ground, the compression spring is compressed to generate a spring restoring force to offset part of the load.

10. The wearable exoskeleton with auxiliary back frame support of claim 7, wherein the lower limb link rod set further comprises:
an above-ankle link rod hinged to the under-knee link rod group;
a return cylinder hinged to the upper ankle link rod, the return cylinder comprises a round wire spring; and
an under-ankle link rod hinged to the return cylinder and configured to contact the ground.
